(19) United States
(12) Patent Application Publication
(10) Pub. No.: US 2015/0363416 A1
(43) Pub. Date: Dec. 17, 2015

(54) SWIM LANE DISPLAY MODE FOR FILE SYSTEM CONTENT

(71) Applicant: LENOVO ENTERPRISE SOLUTIONS (SINGAPORE) PTE. LTD., Now Tech Park (SG)

(72) Inventors: Barry A. Kritt, Atlantic Beach, NC (US); Sarbajit K. Rakshit, Kolkata (IN)

(21) Appl. No.: 14/302,671

(22) Filed: Jun. 12, 2014

(51) Int. Cl. G06F 17/30; G06F 17/24; H04L 29/06; G06F 3/0484; G06F 3/0481

(52) U.S. Cl. CPC G06F 17/30115; G06F 3/0484; G06F 3/0481; H04L 65/403; G06F 17/248

(57) ABSTRACT

A computer file system contains items such as files and folders represented by identifiers such as file names and folder names. When a user of the file system selects a swim lane process flow diagram display mode, a navigation tool selects a swim lane display template. The swim lane display template provides interconnected process blocks arranged into swim lanes. A swim lane represents an organizational unit, and the process blocks located within the swim lane are associated with that organizational unit. The navigation tool then assigns the identifiers to the various process blocks in the template, for example by determining that the identifiers satisfy rules associated with the process blocks to which they are assigned. The populated swim lane display template is then displayed to the user.

### BACKGROUND

The present disclosure relates to computer file system access and management, and more specifically relates to navigation tools for presenting the contents of a computer's file system to a user.

Many computer operating systems provide a navigation tool with a graphical user interface that allows a user to browse the names of files and folders contained in the computer's file system. The user can then open a file or view the contents of a folder by selecting the name associated with the file or folder.

### SUMMARY

Disclosed herein are embodiments of a method, computer program product, and system for presenting identifiers to a user of a computer file system in the form of a swim lane process flow diagram. The identifiers represent items in the computer file system, such as folders and files, and the identifiers may be folder names and file names. A processor executing a navigation tool or other computer module determines that the user has selected a swim lane process flow diagram display mode. The processor then selects a swim lane display template. The swim lane display template provides interconnected process blocks arranged into swim lanes. A swim lane represents an organizational unit, and the process blocks located within the swim lane are associated with that organizational unit.

The processor then assigns the identifiers to the process blocks of the selected swim lane display template, and then displays all or part of the populated swim lane display template to the user. In some embodiments, each of the process blocks is associated with one or more rules, and each identifier satisfies a rule for the process block to which it is assigned. The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an example swim lane display for computer file system content, in accordance with an embodiment of the disclosed invention.

FIG. 2 is a flow diagram illustrating an example method for constructing a swim lane display template, in accordance with an embodiment of the disclosed invention.

FIG. 3 is a flow diagram illustrating an example method for populating a swim lane display template with items from a computer file system, in accordance with an embodiment of the disclosed invention.

FIG. 4 is a high-level block diagram of an example system for implementing one or more embodiments of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer file system management, and more particular aspects relate to navigation tools for presenting the contents of a computer's file system to a user. While the present disclosure is not necessarily limited to such applications, various aspects of the disclosure may be appreciated through a discussion of various examples using this context.

Many computer operating systems provide a navigation tool with a graphical user interface that allows a user to browse identifiers from the computer's file system. The identifiers represent items in the file system, such as files and folders. Identifiers are displayed to the user in a variety of ways, and are sometimes displayed along with icons. An icon is a visual cue providing additional information about the item represented by the identifier, such as whether the item is a file or a folder, or whether a file item is a text file, an image file, an executable file, a file recognizable by a particular application, or some other type of file. Furthermore, identifiers are sometimes displayed along with other details about the item, such as file type, creation date, modification date, or size. Users may be able to control aspects of the display, such as whether to display large icons, small icons, or no icons; whether to display the identifiers in list form, tile form, or some other form; and whether to display some or all of the additional details.

A user may be able to open a file, view the contents of a folder, or otherwise access an item in the file system by selecting a displayed identifier. But a user may have difficulty determining which identifier represents a particular file that the user is looking for unless the user knows the exact identifier for the particular file and the identifiers' exact file path. In determining which identifiers to select, it may be useful for the user to know more about how the files, folders, and other items in the file system are related to each other, how the items are used in a process, or what individuals or groups are responsible for maintaining the items.

A user may be better able to see such relationships and interdependencies among items in a file system if the item identifiers are displayed based on a swim lane diagram. A swim lane diagram is a flow diagram for a process in which sub-process blocks and decision blocks are grouped visually by placing them in swim lanes. Parallel lines divide the diagram into the swim lanes, either horizontally or vertically, with each individual swim lane representing a different organizational unit related to the process. For example, the organizational units may be individuals, departments, business units, teams, or any other organizational unit related to the process. An organizational unit's swim lane may contain the sub-processes for which that organizational unit is responsible.

To view the contents of a particular folder in a computer's file system using a swim lane display, a user may use a keyboard, mouse, touchpad, touch screen, or other input device to navigate to and select the folder and then use the input device to select a swim lane display mode. In some embodiments, the user may select from multiple swim lane display modes. The navigation tool may then choose an appropriate swim lane display template and populate the template with the folder names, file names, and other identifiers found in the selected folder. Related items in the folder are then displayed in the various swim lanes. For example, identifiers for architectural items may be displayed in a first swim lane, identifiers for design items may be displayed in a second swim lane, identifiers for development items may be displayed in a third swim lane, and identifiers for test items may be displayed in a fourth swim lane. Construction and population of a swim lane display template will be discussed in more detail below.

A swim lane display may be created from a swim lane display template based on a swim lane process flow diagram. Individual blocks in the swim lane display may represent the sub-process blocks in the swim lane process flow diagram, and the display template may associate the display blocks with their respective sub-process blocks, for example through a description assigned to the display blocks or through keywords assigned to the display blocks. In some embodiments, a title or name describing the sub-process may be included in the display blocks. The navigation tool may then assign the items found in the selected folder to individual blocks in the swim lane display by matching the keywords or other description of the display blocks to the contents of the selected folder. The assignment of items to display blocks is discussed in more detail below.

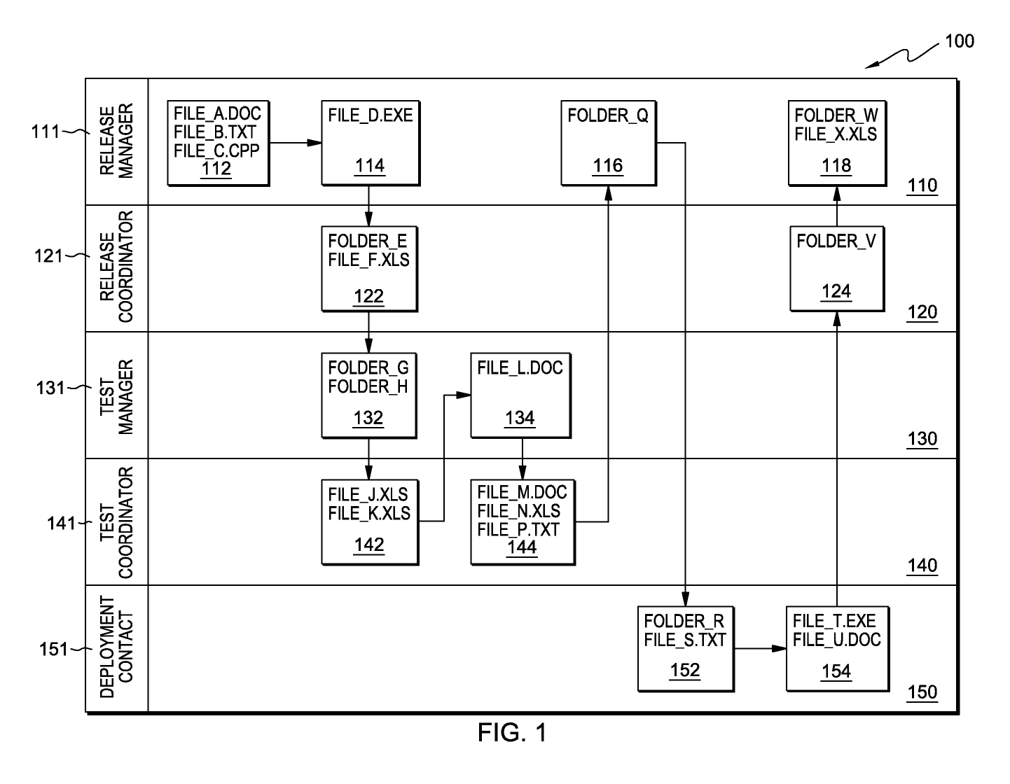

To illustrate how file system contents are presented in a swim lane display mode, FIG. 1 depicts an example swim lane display 100 for computer file system content. The example swim lane display 100 is based on a fictional release and test management process and has been populated with the contents of a fictional folder selected by a user. The contents of the fictional folder (FILE_A.DOC, FILE_B.TXT, FILE_C.CPP, FILE_D.EXE, FOLDER_E, FILE_F.XLS, etc.) have been assigned to the various blocks 112, 114, 116, 118, 122, 124, 132, 134, 142, 144, 152, and 154 in the swim lane display 100 by the navigation tool.

The basic flow of the fictional release and test management process is represented in the swim lane display 100. Five different organizational units (Release Manager, Release Coordinator, Test Manager, Test Coordinator, and Deployment Contact) are responsible for sub-processes in the fictional release and test management process, and therefore the swim lane display 100 contains five swim lanes. A first swim lane 110 is labeled “Release Manager” 111, a second swim lane 120 is labeled “Release Coordinator” 121, a third swim lane 130 is labeled “Test Manager” 131, a fourth swim lane 140 is labeled “Test Coordinator” 141, and a fifth swim lane 150 is labeled “Deployment Contact” 111. Although the swim lanes of swim lane display 100 are displayed horizontally, some embodiments may display swim lanes vertically.

The basic flow of the fictional release and test management process may begin with a package release preparation sub-process followed by a package release finalization sub-process, where the release manager has responsibility for both sub-processes. These two sub-processes are represented by block 112 and block 114 in swim lane 110 of swim lane display 100. In some embodiments (not shown), block 112 may be labeled with “Package Release Preparation” and block 114 may be labeled with “Package Release Finalization.” The navigation tool has determined that items FILE_A.DOC, FILE_B.TXT, and FILE_C.CPP are associated with the package release preparation sub-process, and therefore the navigation tool displays the identifiers for these items in block 112. The navigation tool has determined that item FILE_D.EXE is associated with the package release finalization sub-process and therefore displays the identifier for this item in block 114.

From the package release finalization sub-process, represented by block 114, the fictional process may proceed to a deployment plan sub-process under the control of the release coordinator. The deployment plan sub-process is represented by block 122 in swim lane 120. The navigation tool has determined that items FOLDER_E and FILE_F.XLS are associated with the deployment plan sub-process and therefore the navigation tool displays the identifiers for these items in block 122. From the deployment plan sub-process represented by block 122, the fictional process may proceed to a functional test sub-process under the control of the test manager. The functional test sub-process is represented by block 132 in swim lane 130. The navigation tool has determined that items FOLDER_G and FOLDER_H are associated with the functional test sub-process and therefore displays the identifiers for these items in block 132.

The navigation tool displays the identifiers for the remaining items from the fictional selected folder in the various blocks representing sub-processes of the fictional release and test management process as shown in FIG. 1. A user viewing the swim lane display 100 can easily determine which group or individual has responsibility for which items by noting in which swim lane the items are displayed. For example, items FOLDER_R, FILE_S.TXT, FILE_T.EXE, and FILE_U.DOC, displayed in blocks 152 and 154 of swim lane 150, are the responsibility of the deployment contact, as shown in label 151. The user may also easily determine how the files in the selected folder are related to the process represented by swim lane display 100. For example, a user may be searching for a file related to a regression test plan, and may know that the regression test plan is represented by block 134, but may not know the exact name of the file. This user can easily see that item FILE_L.DOC is related to the regression test plan because it is displayed in block 134, and therefore may have some confidence that FILE_L.DOC is the appropriate file. Another user may be searching for all files for which the release coordinator, represented by swim lane 120, is responsible, but may not know the exact file names. This user can see that items FOLDER_E, FILE_F.XLS, and FOLDER_V are the responsibility of the release coordinator because they are displayed in swim lane 120 labeled “Release Coordinator” 121.

In some embodiments, only part of the swim lane display 100 may be visible, and navigational objects such as horizontal and vertical scroll bars or sliders may allow the user to shift the display up, down, left, and right. Furthermore, individual swim lanes and individual display blocks may include such navigational objects. For example, if display block 144 is too small to display all three identifiers FILE_M.DOC, FILE_N.XLS, and FILE_P.TXT, a vertical scroll bar within the display block 144 may allow the user to scroll up and down to see all three identifiers. In addition, horizontal scroll bars may allow the user to scroll left and right to see additional details associated with the identifiers, such as last saved date or file size.

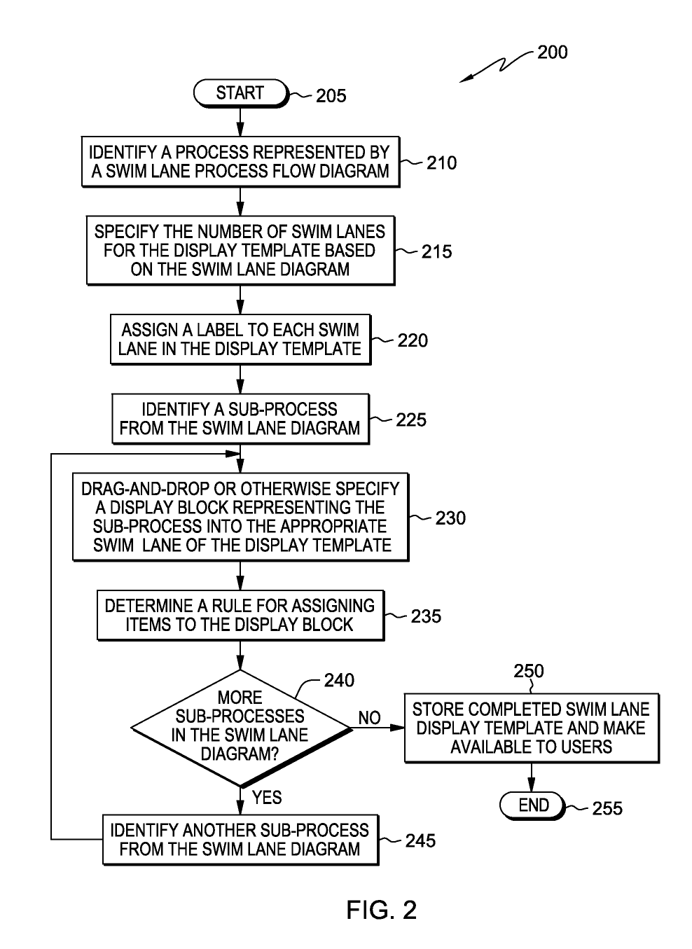

Before a user can select a swim lane display mode, the user must have access to a swim lane display template. The user may construct the template or may have access to a template constructed by another user. Swim lane display templates may be constructed using a swim lane display template generator. A swim lane display template generator may be integrated with and/or provided as part of the navigation tool, may be provided as a stand-alone utility, or may be provided in some other way. An example method 200 for constructing a swim lane display template is illustrated in FIG. 2.

From start 205, a user may identify a process, represented by a swim lane process flow diagram, on which to base the template at 210. From the swim lane process flow diagram, the user may determine the number of swim lanes represented in the flow diagram, and may specify this number to the template generator at 215. Using the number of swim lanes specified, the template generator may provide a swim lane display framework to assist the user in further constructing the template.

At 220, for each swim lane, the user may assign a label identifying the organizational unit represented by the swim lane. The user may also specify one or more rules for use in assigning items to display blocks within the swim lane. For example, if a swim lane represents a “Deployment” organizational unit, a rule associated with the “Deployment” swim lane may provide a list of keywords that are commonly found in documents associated with the deployment process. The navigation tool may then apply this rule when populating the display template with items from the file system.

After, or concurrently with, specifying the number and type of swim lanes for the swim lane display template, the user may then complete construction of the template by specifying individual display blocks within the swim lanes. In some embodiments, the user may specify a display block for each sub-process represented in the swim lane diagram upon which the template is based. In some embodiments, multiple sub-processes may be combined into a single display block, or a single sub-process may be split into multiple display blocks.

At 225, the user may identify a sub-process from the swim lane diagram. At 230, the user may specify a display block to represent the identified sub-process in the swim lane display template under construction. For example, the template generator may allow the user to select a particular style of display block from a group of candidates, and then drag-and-drop the selected display block into the desired location within a particular swim lane. At 235, the user may then customize the display block by specifying one or more rules for use in assigning items to the display block. For example, if the display block represents a “Release Support” sub-process in the “Deployment” swim lane, a rule associated with the “Release Support” sub-process may provide a list of keywords that are commonly found in documents associated with the “Release Support” sub-process. The navigation tool may then apply this rule when populating the display block with items from the file system. Before assigning an item to the display block, the navigation tool may require that the item also satisfy any rule associated with the swim lane in which the display block is located.

If there are more sub-processes in the swim lane diagram at 240, the user may identify the next sub-process at 245 and similarly specify a new display block to represent the next identified sub-process in the swim lane display template under construction. When all sub-processes have been processed, the completed swim lane display template may be stored and made available at 250. The template may be stored locally for the user who constructed it, and may also be made available to other users, for example, by storing the template on a centralized server. In some embodiments, one or more swim lane display templates may be made available for sharing among “friends” or other connected users on a social networking site. Construction of the swim lane display template is complete at 255.

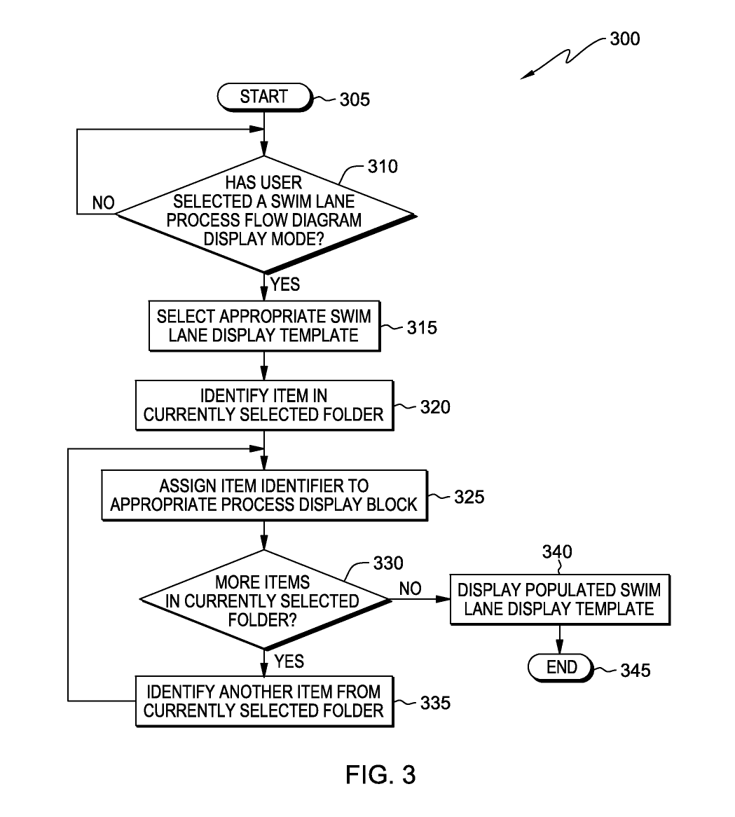

An example method 300 for populating a swim lane display template is illustrated in FIG. 3. From start 305, if a user selects a swim lane display mode at 310 to view the contents of a folder in a computer's file system, the navigation tool may select an appropriate swim lane display template at 315. In some embodiments, the user may specify a particular template, and the navigation tool selects the specified template. In some embodiments, the navigation tool may determine, without input from the user, an appropriate template. The navigation tool may base selection of an appropriate template on the content targeted for display. For example, the navigation tool may compare file and folder names, file content, file metadata, and other data associated with the content to rules and other data associated with the various available display templates to find an appropriate match. For example, the navigation tool may associate one group of files and folders with a software development life cycle process, and may associate a different group of files and folders with a quality control process. If the navigation tool has access to a display template for both processes, then the navigation tool may select whichever display template corresponds to the content targeted for display.

After the template is selected, the navigation tool may populate the template with the folder names, file names, and other identifiers found in the folder targeted by the user for swim lane display. The navigation tool may identify a first item at 320, and may assign the item to a display block at 325 based on any rules associated with the display block and any rules associated with the swim lane containing the display block. Assigning the item to a display block may involve one or more of a variety of determinations. For example, the item's identifier may satisfy a rule for the display block, such as having a particular file name or file extension. If the item is an image file or a video file, assigning the item to a display block may involve performing a contextual analysis of the image or video file. Such a contextual analysis may produce results that satisfy a rule for the display block. In some embodiments, a “keywords” field of the item's file properties may contain keywords that satisfy a rule for the display block. Such keywords may have been manually or automatically entered into the item's “keywords” field when the file was created or updated. For example, the navigation tool may search the item's contents for various keywords associated with one or more swim lane display templates. If the keywords are found, then the navigation tool may store those keywords in the item's file properties for later use in populating a swim lane display template.

If there are more items in the targeted folder at 330, the navigation tool may identify the next item at 335 and similarly assign the item to a display block at 325. When all items in the target folder are processed, the populated swim lane display template is displayed at 340, and the method is complete at 345.

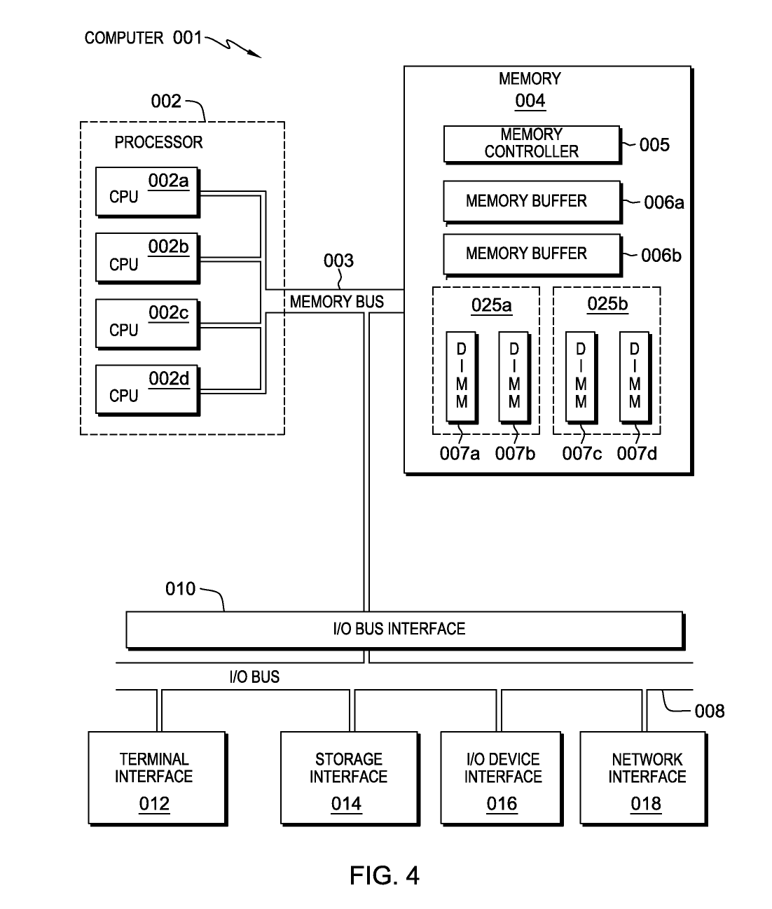

FIG. 4 depicts a high-level block diagram of an example system for implementing one or more embodiments of the invention. The mechanisms and apparatus of embodiments of the present invention apply equally to any appropriate computing system. The major components of the computer system 001 comprise one or more CPUs 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffers 006 and one or more memory devices 007. In the illustrated embodiment, the memory devices 007 may be dual in-line memory modules (DIMMs), which are a series of dynamic random-access memory (DRAM) chips 015a-015n (collectively referred to as 015) mounted on a printed circuit board and designed for use in personal computers, workstations, and servers. The use of DRAMs 015 in the illustration is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 4 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 4 is intended to depict the representative major components of an exemplary computer system 001. But individual components may have greater complexity than represented in FIG. 4, components other than or in addition to those shown in FIG. 4 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be an intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM 0015 may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for presenting a plurality of identifiers to a user of a computer file system, each identifier representing at least one item in the computer file system, the method comprising:
determining that the user has selected a swim lane process flow diagram display mode for the displaying the plurality of identifiers;
selecting a swim lane display template, the swim lane display template providing a plurality of interconnected process blocks arranged into a plurality of swim lanes, each swim lane representing an organizational unit, each process block in a swim lane associated with the organizational unit represented by the swim lane;
assigning each identifier to a process block in the swim lane display template; and
displaying at least part of the swim lane display template, the swim lane display template populated with the plurality of identifiers.

2. The method of claim 1, wherein the plurality of identifiers includes at least one of a file name and a folder name.

3. The method of claim 1, wherein each of the plurality of process blocks is associated with a rule, and wherein each identifier assigned to the process block satisfies the rule associated with the process block.

4. The method of claim 3, wherein a first identifier is assigned to a first process block, wherein metadata associated with the first identifier includes a keyword, and wherein the rule associated with the first process block specifies the keyword.

5. The method of claim 1, further comprising:
constructing the swim lane display template.

6. The method of claim 5, further comprising:
making the swim lane display template available for sharing among connected users on a social networking site.

7. The method of claim 5, wherein the constructing includes associating a first rule with a first process block.

8. A computer program product for presenting a plurality of identifiers to a user of a computer file system, each identifier representing at least one item in the computer file system, the computer program product comprising a computer readable storage medium having program instructions embodied therewith, the program instructions executable by a processor to perform a method comprising:
determining that the user has selected a swim lane process flow diagram display mode for the displaying the plurality of identifiers;
selecting a swim lane display template, the swim lane display template providing a plurality of interconnected process blocks arranged into a plurality of swim lanes, each swim lane representing an organizational unit, each process block in a swim lane associated with the organizational unit represented by the swim lane;
assigning each identifier to a process block in the swim lane display template; and
displaying at least part of the swim lane display template, the swim lane display template populated with the plurality of identifiers.

9. The computer program product of claim 8, wherein the plurality of identifiers includes at least one of a file name and a folder name.

10. The computer program product of claim 8, wherein each of the plurality of process blocks is associated with a rule, and wherein each identifier assigned to the process block satisfies the rule associated with the process block.

11. The computer program product of claim 10, wherein a first identifier is assigned to a first process block, wherein metadata associated with the first identifier includes a keyword, and wherein the rule associated with the first process block specifies the keyword.

12. The computer program product of claim 8, the method further comprising:
constructing the swim lane display template.

13. The computer program product of claim 12, the method further comprising:
making the swim lane display template available for sharing among connected users on a social networking site.

14. The computer program product of claim 12, wherein the constructing includes associating a first rule with a first process block.

15. A computer system for presenting a plurality of identifiers to a user of a computer file system, each identifier representing at least one item in the computer file system, the computer system comprising:
a memory; and
a processor in communication with the memory, wherein the computer system is configured to perform a method, the method comprising:
determining that the user has selected a swim lane process flow diagram display mode for the displaying the plurality of identifiers;
selecting a swim lane display template, the swim lane display template providing a plurality of interconnected process blocks arranged into a plurality of swim lanes, each swim lane representing an organizational unit, each process block in a swim lane associated with the organizational unit represented by the swim lane;
assigning each identifier to a process block in the swim lane display template; and
displaying at least part of the swim lane display template, the swim lane display template populated with the plurality of identifiers.

16. The computer system of claim 15, wherein the plurality of identifiers includes at least one of a file name and a folder name.

17. The computer system of claim 15, wherein each of the plurality of process blocks is associated with a rule, and wherein each identifier assigned to the process block satisfies the rule associated with the process block.

18. The computer system of claim 17, wherein a first identifier is assigned to a first process block, wherein metadata associated with the first identifier includes a keyword, and wherein the rule associated with the first process block specifies the keyword.

19. The computer system of claim 15, the method further comprising:
constructing the swim lane display template.

20. The computer system of claim 19, the method further comprising:
making the swim lane display template available for sharing among connected users on a social networking site.
